(19) United States
(12) Patent Application Publication
(10) Pub. No.: US 2003/0074758 A1
(43) Pub. Date: Apr. 24, 2003

(54) Sleeve shaped sponge roller particularly for use in applying a wallpaper adhesive

(76) Inventor: Linda Mitchell, Nashville, TN (US)

Correspondence Address: Douglas J. McEvoy, Gifford, Krass, Groh, Sprinkle,, Anderson & Citkowski, P.C., 280 North Old Woodward, Suite 400, Birmingham, MI, 48009, US

(21) Appl. No.: 10/001,294

(22) Filed: Oct. 23, 2001

(51) Int. Cl. B05C 17/02

(52) U.S. Cl. 15/230.11; 492/13; 492/19

(57) ABSTRACT

A roller for use with an applicator device in the application of a viscous fluid onto a wall surface. The device includes a handle and an arcuately configured and extending neck which terminates in an elongate extending and rotatable support such as a plurality of spaced apart and parallel extending wire frame elements. The roller includes a substantially sleeve shaped body having an outwardly facing surface and an inwardly facing surface dimensioned to be slidably engaged over the rotatable support. An outwardly facing surface of the sleeve shaped body further exhibits a porous and honeycombed nap configuration such that, upon immersing the sleeve shaped body into a pool of the viscous fluid, the honeycombed nap configuration permits a desired volume of the fluid to be absorbed for subsequent and even application over a selected surface area of the wall surface.

### BACKGROUND OF THE INVENTION

1. Field of the Invention

The present invention relates generally to roller applicator devices. More particularly, the present invention teaches a generally cylindrical and sleeve shaped roller applicator constructed of a sponge nap material and which, in an improvement over prior art foam and cloth applicators, provides increased viscous fluid retention and application characteristics, particularly in use with thicker fluidic adhesives and such as are typically applied prior to the layering of a wallpaper or like wall covering material.

2. Description of the Prior Art

Paint and wallpaper adhesive roller devices are fairly well known in the art. The most common type of roller is the foam roller having a specified length, diameter and foam nap. The dimensions of the foam nap typically range in the area of ⅜″.

It has been found that the typical foam roller, while generally being capable of adequately absorbing and reapplying volumes of paints, stains and varnishes, is poorly adapted for use in absorbing and reapplying volumes of viscous based wallpaper adhesive and largely due to its fine and relatively small density foam material construction. An additional problem with such foam material being utilized to absorb and reapply such adhesive further results from the greater density and weight associated with such fluid based adhesives and the fact that the conventional foam roller is very limited in the porous holding capability as a result of its given nap configuration. As such, the fluid adhesive tends to adhere only to the top surface of the foam roller and is substantially transferred onto the wall surface in the course of the initial swipe or stroke of the roller, thus greatly reducing the ability to evenly apply the adhesive on the wall surface.

It has been found that rollers utilizing a given cloth nap design will in fact permit a small amount of paste to absorb into the nap. However, much the same result as with the foam roller is achieved upon application and with substantially all the fluid adhesive being transferred on the initial swipe across the wall surface, resulting in generally thin and uneven application. This further causes the applied adhesive to dry quickly, making the application of the wall covering (wallpaper, border, etc.) more difficult. It is additionally known to apply adhesives using a hand brush and, while being generally capable of absorbing and applying a minimal volume of fluid adhesive, the paste brush suffers from many of the shortcomings of foam and cloth nap rollers in that much of the retained adhesive is released/reapplied.

Additional examples of wall covering apparatuses are known in the prior art and a first example of which is referenced in U.S. Pat. No. 4,834,237, issued to Henke, et al. which teaches the provision of a wall covering kit having a tray, cover, and plurality of tool storage compartments. Among the tool implements used with the tray kit are a standard nap roller and a substantially planar and rectangular shaped sponge (see illustrated in broken lines at 33 in Henke). Henke does not however teach or suggest the incorporation of a sponge mat or nap design into the roller implement, nor any inspiration for doing the same, including the desire to evenly and completely apply a fluid adhesive or the like.

Also, U.S. Pat. No. 5,837,084, issued to Barss, teaches an improved method of making a single-cell honeycomb fabric structure including the formation of a double-cell honeycomb fabric structure from a single continuous length of foldable material and which further removes parts of the cells defining a face of the double honeycomb structure in order to obtain a desired single-cell structure having folded outwardly extending pleats on one face and tabbed outwardly extending pleats on the other face. Barss does not teach or suggest the application of such technology to the formation of an adhesive sponge nap roller or like applicator.

### SUMMARY OF THE PRESENT INVENTION

The present invention teaches a generally cylindrical and sleeve shaped roller applicator constructed of a sponge nap material and which, in an improvement over prior art foam and cloth nap roller applicators, as well as hand-held brush applicators, in that the sponge roller provides increased viscous fluid retention and application characteristics, particularly in use with thicker fluidic adhesives and such as are typically applied prior to the layering of a wallpaper or like wall covering material. More specifically, the incorporation of a sponge nap (or honeycombed) design, such as is filled with cavities or tunnels, is designed into the roller of the present application provides the ability to more quickly and evenly apply an optimal quantity of a viscous sponge adhesive, such fluid adhesives typically having a greater density or weight than other types of paint, varnish or stain for which prior art foam rollers are typically known to be used.

In the preferred variant, the roller applicator includes a substantially sleeve shaped body having an outwardly facing surface and an inwardly facing surface dimensioned to be slidably engaged over the rotatable support associated with the application device. In particular, a hollow core element constructed of a moisture and solvent resistant material may be employed as an intermediary between the inwardly facing surface of the body and the rotatably associated support of the applicator device, such including a plurality of spaced apart and parallel extending wire frame elements.

The exterior or outwardly facing surface of the sleeve shaped body further includes a desired porous and honeycombed nap configuration with specified pore density and size, the purpose of which being to adequately absorb and uniformly apply the volumes of the fluidic/viscous adhesive. It is also desirous that the sponge nap be drawn from a selected material (including polyester polyurethane and polyester hydrophilic material), exhibit minimal thickness (typically at least ½″), as well as minimal hardness (at least 2.5 kilo Pascals). It is also known in an alternate variant that the body may be initially provided in a substantially planar shape which is wound and adhesively secured onto the exterior facing surface of the intermediary core element, or directly upon the rotatable applicator support.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view of a substantially sleeve shaped sponge roller according to a first preferred embodiment of the present invention;

FIG. 2 is a cutaway side view of the sponge nap roller and taken along line 2-2 of FIG. 1 and further showing in enlarged fashion the honeycombed nap construction of the roller, combined with its slidable engagement upon the existing wire elements constituting the roller frame;

FIG. 3 is a partially exploded view in perspective and illustrating the slidably engageable nature of the sleeve shaped and sponge nap roller upon such as a hollow core element;

FIG. 4 is a view similar to that shown in FIG. 2, and illustrating a further preferred variant of the present invention and in which the sponge nap material is provided initially in a substantially planar shape and is wound and adhesively secured onto the core element; and

FIG. 5 is a perspective view of the sponge nap roller according to a further, and reduced dimension, variant of the present invention.

### DETAILED DESCRIPTION OF THE PREFERRED EMBODIMENT

Referring now to FIG. 1, the substantially sleeve shaped and sponge nap roller is illustrated at 10 according to a first preferred embodiment of the present invention. As previously described, the present invention is an improvement over prior art foam and cloth nap roller applicators, as well as hand-held brush applicators, in that the honeycombed structure of the sponge roller provides increased viscous fluid retention and even application characteristics, particularly in use with thicker fluidic adhesives and such as are typically applied prior to the layering of a wallpaper or like wall covering material. Of additional advantage, the incorporation of the sponge nap (or honeycombed) design into the roller of the present application provides the ability to more quickly and evenly apply an optimal (and typically less than with foam rollers) quantity of a viscous sponge adhesive, such fluid adhesives typically having a greater density or weight than other types of paint, varnish or stain for which prior art foam rollers are typically known to be used.

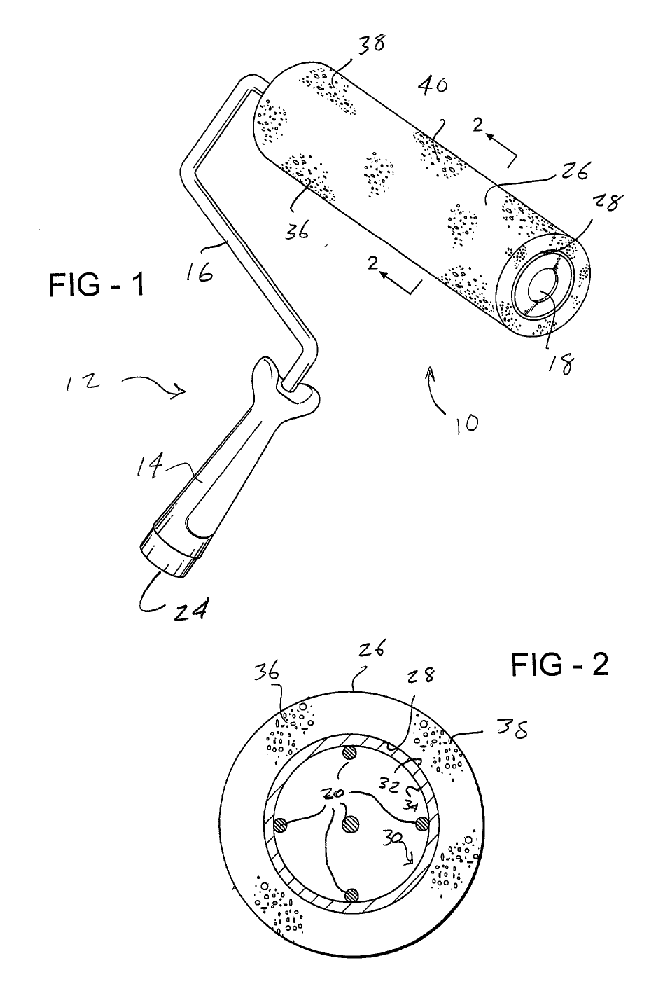

Referring again to FIG. 1, the sponge nap roller 10 is again illustrated in combination with an applicator device, generally represented at 12, and for use in the application of the viscous fluid (not shown) onto a wall surface. The applicator device is by itself relative known in the art and includes such features as a handle 14, an arcuately configured and extending neck 16, having a specified number of succeeding bends, and which terminates in an elongate extending and rotatable support 18. Referring again to the cross sectional cutaway of FIG. 2, the rotatable support may, as is conventionally known, further include a plurality (such as five) of spaced apart and parallel extending wire frame elements and as are collectively shown at 20 in FIG. 2. Although not shown, it is also understood that an elongated pole or other suitable attachment may be engaged (typically in threaded fashion) with a selected insertion end 24 of the handle 14 and as is well known in the art.

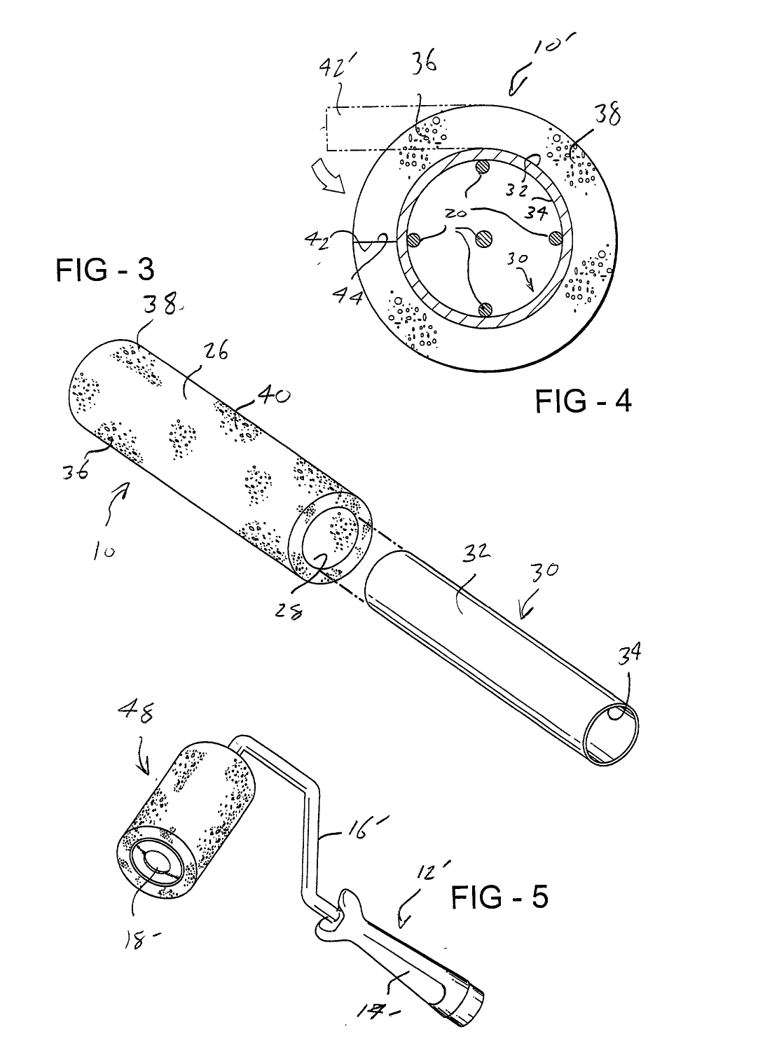

Referring again to FIG. 1, as well as to FIGS. 2 and 3, the roller 10 is again illustrated and includes a substantially sleeve shaped body having an outwardly facing surface 26 and a corresponding and inwardly facing surface 28. A hollow and intermediary core element 30 is (optionally) provided and includes a specified length and diameter. The core element 30 is also preferably constructed of a moisture and solvent resistant material (such as a poly vinyl chloride (PVC) or phenolic material), the core 30 further including an outwardly facing surface 32 and an opposite and inwardly facing surface 34.

As best illustrated in reference to FIGS. 2 and 3 in combination, the inwardly facing surface 28 of the sleeve shaped body is frictionally and slidably engaged upon the exterior/outwardly facing surface 32 of the core element 30, which is in turn likewise frictionally and slidably engaged over the wire frame elements 20 constructing the rotatable support 18. It is however understood that provision of the core element 30 is not required or, alternatively, the inwardly facing surface 28 of the sleeve shaped body may be integrally coated or applied with a reinforcing material.

Referring again to the various figure illustrations, the exterior/outwardly facing surface 26 of the sleeve shaped body exhibits a desired porous and honeycombed nap configuration, and which is in particular illustrated by a plurality of combed and cell shaped portions 36, 38, 40 et. seq., arrayed substantially across and along the entire exterior surface 26 of the sleeve shaped body 10. As described, previously, the purpose of the honeycombed and porous configuration of the roller 10, defining in effect the “sponge” like characteristics set forth by the present invention, is to enable the user to adequately absorb and retain sufficient volumes of applicable fluid, such as in particular heavier density fluids such as viscous wallpaper adhesive.

Additionally, the honeycombed and porous configuration of the sponge roller provides for the even and continuous application of the fluid (such as ideally the wallpaper and wallpaper border adhesive) and such that a given volume of the fluid adhesive can be equally and optimally applied over a selected area of the wall surface. As previously described, a major shortcoming of the prior art is not only the inability to absorb any significant volume of adhesive, but also the tendency of the limited volume of adhesive (surface adhered to the conventional foam roller) to be substantially transferred in an uneven and initial roller stroke or swipe, the result of this again being quick and uneven drying of the adhesive before the wall covering material can be adequately sized and massaged into place.

It is additionally been found that certain minimal characteristics of the sponge shaped body and nap construction provide for enhanced performance characteristics. Such characteristics include selecting the sponge design of the sleeve shaped body from materials including polyester hydrophilic and polyester polyurethane materials, such as which may be further engineered to incorporate certain minimal pore density and sizes. In particular, a density range of at least 15 kilograms per cubic meter, and ranging up to 32 kilograms per cubic meter, has been found to be one ideal range in that it provides a pore size to the sponge nap of sufficient size to adequately absorb and retain fluid, while at the same time not being so large (or lesser in density) that fluid/adhesive cannot be evenly applied later on. In contrast, the density sizes of foam roller naps tend to be much higher, in some cases upwards of 80 kilograms per cubic meter, and which result in significantly decreased absorption capacity, in particular for heavier viscous fluids such as adhesives. In testing, it has been found that sponge-nap rollers as constructed above exhibit absorption and retention capability of fluid adhesives which may exceed two times or more the relative absorption and retention capacity provided by traditional foam nap rollers. Additional performance aspects of the sponge mat design may ideally include the configuration of the body as having at least a ½″ thickness and with a hardness rating of at least 2.5 kilo Pascals.

Referring to FIG. 4, an alternate variant of the sponge roller design of the present invention is illustrated and includes the body 10′ being initially provided in a substantially think and planar (and typically rectangular) shape and which includes opposite adjoining and abutting edges 42 and 44. Typically, the planar sheet 10′ can be applied, typically wound, onto the core element 30 (in the fashion illustrated by the direction of folding of end 42′ (illustrated in phantom) and with the application of an underlaying adhesive of any suitable type applied to either or both the core element 30 and/or the abutting surface of the planar sheet 10′.

Finally, and referring to FIG. 5, a further variant 48 of the sponge roller of the present invention is illustrated and which, aside from a reduced size, is configured and constructed in substantially identical fashion as the roller illustrated at 10 in FIGS. 1-4. The substantially sleeve shaped body of the smaller sized (reduced length) roller is ideal for applying adhesives to narrow border locations and it has also been found that the narrow sized fits easily into smaller, quart sized buckets in which border adhesives are normally packaged.

Accordingly, the present invention discloses a novel and useful roller design, incorporating a unique and sponge-nap configuration, for applying a wallpaper adhesive and which is an improvement over prior art foam and cloth nap adhesives. Having described my invention, additional preferred embodiments will become apparent to those skilled in the art to which it pertains, and without deviating from the scope of the appended claims.

I claim:

1. A roller for use with an applicator device in the application of a viscous fluid onto a surface, the device including a handle and an arcuately configured and extending neck which terminates in an elongate extending and rotatable support, said roller comprising:
a substantially sleeve shaped body having an outwardly facing surface and an inwardly facing surface dimensioned to be slidably engaged over the rotatable support;
said outwardly facing surface of said sleeve shaped body further exhibiting porous and honeycombed nap configuration; and
upon immersing said sleeve shaped body into a pool of said viscous fluid, said honeycombed nap configuration permitting a desired volume of the fluid to be absorbed for subsequent and even application over a selected surface area of the surface.

2. The roller as described in claim 1, said sleeve shaped body having a specified length and outer diameter and further comprising a polyester polyurethane material.

3. The roller as described in claim 1, said sleeve shaped body having a specified length and outer diameter and further comprising a material selected from the group including a polyester hydrophilic and polyester polyurethane materials.

4. The roller as described in claim 1, said honeycombed nap configuration further comprising selected pore density and size.

5. The roller as described in claim 4, said nap configuration further comprising a rated pore density in a range of 15 to 32 kilograms per cubic meter.

6. The roller as described in claim l, the viscous fluid further including a fluidic based adhesive for supporting a wall covering, said body evidencing said honeycombed nap configuration further comprising at least a ½″ thickness.

7. The roller as described in claim 1, said sleeve shaped body further comprising a rated hardness of at least 2.5 kilo Pascals.

8. The roller as described in claim 1, further comprising a hollow core element having a specified length and diameter, said inwardly facing surface of said sleeve shaped body being slidably and frictionally engaged over an exterior facing surface of said core element.

9. The roller as described in claim 8, further comprising said core being constructed from a moisture and solvent resistant material selected from the group including poly vinyl chloride (PVC) and phenolic materials.

10. The roller as described in claim 1, the elongate extending and rotatable support portion of the applicator device further including a plurality of spaced and parallel extending wire frame elements, an inwardly facing surface of said core element slidably and frictionally engaging over said wire frame elements.

11. The roller as described in claim 1, further comprising a hollow core element having a specified length and diameter, said body further comprising being initially provided in a substantially planar shape which is wound and adhesively secured onto an exterior facing surface of said core element.

12. A roller for use with an applicator device in the application of a viscous fluid onto a wall surface, the device including a handle and an arcuately configured and extending neck which terminates in an elongate extending and rotatable support, said roller comprising:
a substantially sleeve shaped body having an outwardly facing surface and an inwardly facing surface dimensioned to be slidably engaged over the rotatable support;
said outwardly facing surface of said sleeve shaped body further exhibiting a porous and honeycombed nap configuration exhibiting at least a ½″ thickness and a pore density of at least 15 kilograms per cubic meter; and
upon immersing said sleeve shaped body into a pool of the viscous fluid, said honeycombed nap configuration permitting a desired volume of the fluid to be absorbed for subsequent and even application over a selected area of the wall surface.

13. A roller for use with an applicator device in the application of a viscous fluid onto a surface, the device including a handle and an arcuately configured and extending neck which terminates in an elongate extending and rotatable support, the fluid further including a fluidic based adhesive for supporting a subsequently applied wall covering, said roller comprising:
a substantially sleeve shaped body having an outwardly facing surface and an inwardly facing surface dimensioned to be slidably engaged over the rotatable support;
a core element having a specified length and diameter, said inwardly facing surface of said sleeve shaped body being slidably and frictionally engaged over an exterior facing surface of said core element;
said outwardly facing surface of said sleeve shaped body further exhibiting a porous and honeycombed nap configuration exhibiting at least a ½″ thickness, a pore density in a range of 15-32 kilograms per cubic meter, and a hardness of at least 2.5 kilo Pascals; and
upon immersing said sleeve shaped body into a pool of the fluidic based adhesive, said honeycombed nap configuration permitting a desired volume of the fluid to be absorbed for subsequent and even application over a selected area of the surface.
